(19) United States
(12) Patent Application Publication
(10) Pub. No.: US 2023/0183551 A1
(43) Pub. Date: Jun. 15, 2023

(54) DISSOLUTION OF FILTER CAKE AT LOW TEMPERATURES

(71) Applicant: Halliburton Energy Services, Inc., Houston, TX (US)

(72) Inventors: Sunita Sameer Kadam, Pune (IN); Suhas Shriniwas Belgi, Pune (IN); Shreyasi Goswami, Pune (IN)

(21) Appl. No.: 17/552,274

(22) Filed: Dec. 15, 2021

(51) Int. Cl. C09K 8/528; C09K 8/536; C09K 8/05

(52) U.S. Cl. CPC C09K 8/528; C09K 8/536; C09K 8/05

(57) ABSTRACT

Methods and compositions for dissolving a filter cake. An example method introduces a treatment fluid into an annulus of a wellbore penetrating a subterranean formation. The treatment fluid includes an aqueous fluid and a phosphate. The wellbore has a wall that is at least partially coated with a filter cake. The method further removes at least a portion of the filter cake from the wall.

### TECHNICAL FIELD

The present disclosure relates generally to drilling and wellbore clean-up operations, and more particularly, to dissolving a filter cake in low temperature wells.

### BACKGROUND

Hydrocarbons residing in a subterranean formation may be recovered by drilling a well into the subterranean formation. A drilling fluid may be circulated through the wellbore during the well drilling operation. Some drilling fluids may form a filter cake on the formation face to prevent fluid loss into the subterranean formation. In some wells, the presence of the filter cake may adversely affect fluid flow into a producing well. The filter cake may damage the formation thereby decreasing production and reducing the producing life of the well. In these instances, the filter cake may be removed to improve fluid flow into the wellbore. These removal operations may be difficult to successfully perform in some wellbore environments, such as those with low temperatures.

Regardless of the wellbore environment, successful removal of the filter cake may improve fluid flow into the wellbore, thereby extending the producing life of the well. The present invention provides improved methods and compositions for removing the filter cake from a low temperature wellbore environment.

### BRIEF DESCRIPTION OF THE DRAWINGS

Illustrative examples of the present disclosure are described in detail below with reference to the attached drawing figures, which are incorporated by reference herein, and wherein:

FIG. 1 is a schematic illustrating a system for using a treatment fluid while drilling equipment is present in a wellbore in accordance with one or more examples described herein; and

FIG. 2 is a schematic illustrating an enlarged view of the dissolution of the filter cake by a treatment fluid as illustrated in FIG. 1 and in accordance with one or more examples described herein.

The illustrated figures are only exemplary and are not intended to assert or imply any limitation with regard to the environment, architecture, design, or process in which different examples may be implemented.

### DETAILED DESCRIPTION

The present disclosure relates generally to drilling and wellbore clean-up operations, and more particularly, to dissolving a filter cake in low temperature wells.

In the following detailed description of several illustrative examples, reference is made to the accompanying drawings that form a part hereof, and in which is shown by way of illustration specific examples that may be practiced. These examples are described in sufficient detail to enable those skilled in the art to practice them, and it is to be understood that other examples may be utilized and that logical structural, mechanical, electrical, and chemical changes may be made without departing from the spirit or scope of the disclosed examples. To avoid detail not necessary to enable those skilled in the art to practice the examples described herein, the description may omit certain information known to those skilled in the art. The following detailed description is, therefore, not to be taken in a limiting sense, and the scope of the illustrative examples are defined only by the appended claims.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present invention. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

In the following discussion and in the claims, the terms “including” and “comprising” are used in an open-ended fashion, and thus should be interpreted to mean “including, but not limited to.” Unless otherwise indicated, as used throughout this document, “or” does not require mutual exclusivity.

The terms uphole and downhole may be used to refer to the location of various components relative to the bottom or end of a well. For example, a first component described as uphole from a second component may be further away from the end of the well than the second component. Similarly, a first component described as being downhole from a second component may be located closer to the end of the well than the second component.

The examples described herein relate to the use of treatment fluids to remove the filter cake from a wellbore. The treatment fluid comprises a phosphate. The phosphate dissolves the calcium carbonate component of the filter cake by sequestering the Ca²⁺ ions of the calcium carbonate. Advantageously, the treatment fluid may be used with any type of drilling fluid, clean-up fluid, workover fluid, spotting fluid, etc. and may be provided as a pill in some examples. A further advantage is that the phosphate may dissolve the filter cake in low temperature wellbore environments. A “low temperature” wellbore environment, as used herein, refers to a wellbore temperature of 35° C. or less. An additional advantage is that the reaction rate of the phosphate does not depend on the pH of the treatment fluid. A further advantage is that the treatment fluid has a negligible corrosion rate, and corrosion inhibitors are not needed or optionally used only in small amounts compared to other acid-based filter cake dissolvers to prevent the corrosion of wellbore equipment. A still further advantage is that an optional activator may be used to increase the reaction rate of the phosphate. Another advantage is that the reaction rate may be tuned by the adjustment of the phosphate and/or activator concentration. One further advantage is that salts of the phosphate may impart density to the treatment fluid improving the suspension of partially dissolved filter cake components and reducing the potential for formation damage from sagging or undissolved filter cake remnants.

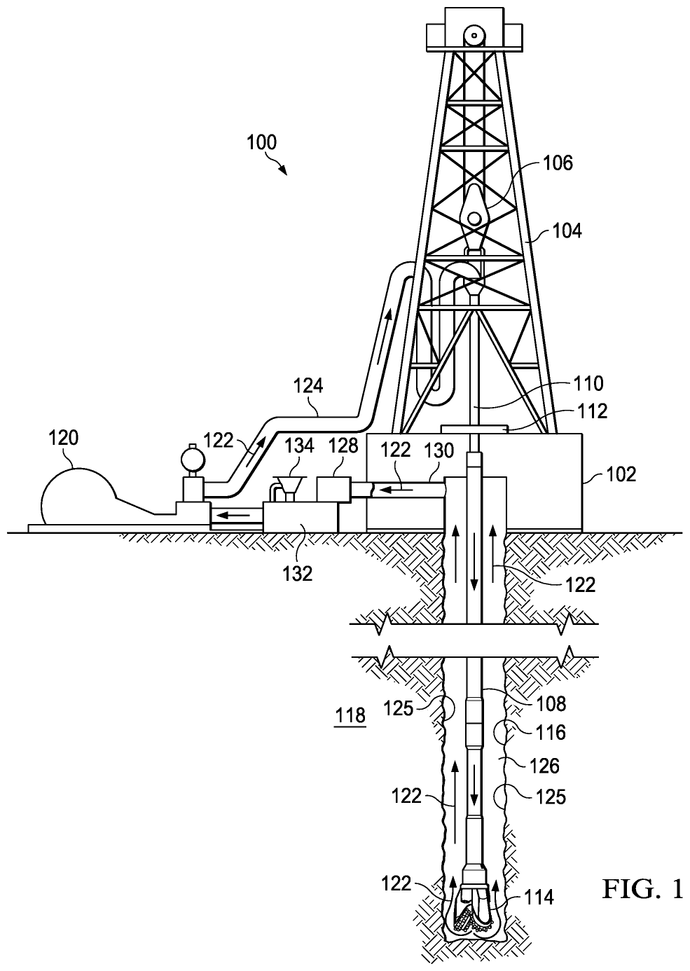

FIG. 1 is a schematic illustrating a system for using a treatment fluid 122 while drilling equipment is present in a wellbore 116 in accordance with the examples disclosed herein. In some alternative examples, the treatment fluid 122 may be introduced into the wellbore 116 when the drilling equipment is not present. The treatment fluid 122 comprises a phosphate. As used herein, “phosphate” includes any molecule that contains a phosphate functional group, including polyphosphates and phosphate salts. The treatment fluid 122 may directly or indirectly affect one or more components or pieces of equipment associated with the exemplary wellbore drilling assembly 100, according to one or more examples. It should be noted that while FIG. 1 generally depicts a land-based drilling assembly 100, those skilled in the art will readily recognize that the principles described herein are equally applicable to subsea drilling operations that employ floating or sea-based platforms and rigs, without departing from the scope of the disclosure.

In some examples, the treatment fluid 122 may be introduced as a part of a drilling fluid. The drilling fluid may be any drilling fluid including aqueous-based drilling fluids, oil-based drilling fluids, synthetic drilling fluids, invert-emulsion based drilling fluids, and the like. Alternatively, the treatment fluid 122 may be introduced into the wellbore 116 as, or part of, a clean-up fluid, spotting fluid, workover fluid, and the like. In some examples, the treatment fluid 122 may be introduced into the wellbore 116 as a pill. A pill is a relatively small quantity (e.g., less than about 500 bbl) of drilling fluid used to accomplish a specific task that the regular drilling fluid cannot perform, e.g., a pipe-freeing pill to, for example, destroy filter cake and relieve differential sticking forces.

In some examples, wellbore 116 may be a low temperature wellbore having a temperature less than 35° C., for example, a wellbore temperature of between about 0° C. to about 35° C. As another example, the wellbore temperature may be between about 20° C. to about 35° C.

In one method, the components of the treatment fluid 122 are mixed while being pumped in the wellbore 116 in an on-the-fly mixing operation. For example, the phosphate and any optional components may be added to an aqueous base fluid and/or a drilling fluid being introduced into the wellbore 116. In this example, the treatment fluid 122 exits a bottom hole assembly 114 and is introduced into the wellbore 116 where it may contact and dissolve a filter cake 125 which may coat at least a portion of the walls of the wellbore 116.

In another method, the treatment fluid 122 is mixed at the surface before use, and then introduced into the wellbore 116 and a drill string 108. The treatment fluid 122 is then introduced into the wellbore 116, pumped through the bottom hole assembly 114, pumped through an annulus 126 where it may contact and dissolve the filter cake 125.

With continued reference to FIG. 1, wellbore drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A bottom hole assembly 114 comprising a bit is attached to the distal end of the drill string 108 and is driven either by a downhole motor and/or via rotation of the drill string 108 from the well surface. As the bit of the bottom hole assembly 114 rotates, it creates the wellbore 116 that penetrates various subterranean formations 118.

A pump 120 (e.g., a mud pump) circulates the treatment fluid 122 through a feed pipe 124 and to the kelly 110, which conveys the treatment fluid 122 downhole through the interior of the drill string 108 and through one or more orifices in the bottom hole assembly 114. The treatment fluid 122 may be introduced prior to, concurrently with, or subsequent to the introduction of a drilling fluid or other treatment fluid (such as a clean-up fluid, spotting fluid, workover fluid, etc.) into the wellbore 116. The treatment fluid 122 may then contact the filter cake 125 to dissolve at least a portion of the filter cake 125. At least a portion of the treatment fluid 122 may be circulated back to the surface, either with or without the presence of another fluid (e.g., drilling fluid) via annulus 126 defined between the drill string 108 and the walls of the wellbore 116. The treatment fluid 122 may carry dissolved and undissolved portions of the filter cake 125 to the surface to be removed from the wellbore 116 thereby preventing formation damage due to the presence of the filter cake 125. At the surface, the treatment fluid 122 exits the annulus 126 and may be conveyed to one or more fluid processing unit(s) 128 via an interconnecting flow line 130. After passing through the fluid processing unit(s) 128, a “cleaned” treatment fluid 122 may be deposited into a nearby retention pit 132 (e.g., a mud pit). While illustrated as being arranged at the outlet of the wellbore 116 via the annulus 126, those skilled in the art will readily appreciate that the fluid processing unit(s) 128 may be arranged at any other location in the wellbore drilling assembly 100 to facilitate its proper function, without departing from the scope of the disclosure.

Optionally, the treatment fluid 122 may also be added to a mixing hopper 134 communicably coupled to or otherwise in fluid communication with the retention pit 132. The mixing hopper 134 may include, but is not limited to, mixers and related mixing equipment known to those skilled in the art. In alternative examples, however, the treatment fluid 122 may not be added to the mixing hopper 134. In at least one example, there could be more than one retention pit 132, such as multiple retention pits 132 in series. Moreover, the retention pit 132 may be representative of one or more fluid storage facilities and/or units where the disclosed treatment fluid 122 may be stored, reconditioned, and/or regulated until desired for use.

As mentioned above, the disclosed treatment fluid 122 may directly or indirectly affect the components and equipment of the wellbore drilling assembly 100. For example, the disclosed treatment fluid 122 may directly or indirectly affect the fluid processing unit(s) 128 which may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, or any fluid reclamation equipment. The fluid processing unit(s) 128 may further include one or more sensors, gauges, pumps, compressors, and the like used to store, monitor, regulate, and/or recondition the exemplary treatment fluid 122.

The treatment fluid 122 may directly or indirectly affect the pump 120, which representatively includes any conduits, pipelines, trucks, tubulars, and/or pipes used to fluidically convey the treatment fluid 122 downhole, any pumps, compressors, or motors (e.g., topside or downhole) used to drive the treatment fluid 122 into motion, any valves or related joints used to regulate the pressure or flow rate of the treatment fluid 122, and any sensors (e.g., pressure, temperature, flow rate, etc.), gauges, and/or combinations thereof, and the like. The disclosed treatment fluid 122 may also directly or indirectly affect the mixing hopper 134 and the retention pit 132 and their assorted variations.

The disclosed treatment fluid 122 may also directly or indirectly affect the various downhole equipment and tools that may come into contact with the treatment fluid 122 such as, but not limited to, the drill string 108, any floats, drill collars, mud motors, downhole motors and/or pumps associated with the drill string 108, and any MWD/LWD tools and related telemetry equipment, sensors or distributed sensors associated with the drill string 108. The disclosed treatment fluid 122 may also directly or indirectly affect any downhole heat exchangers, valves and corresponding actuation devices, tool seals, packers and other wellbore isolation devices or components, and the like associated with the wellbore 116. The disclosed treatment fluid 122 may also directly or indirectly affect the bottom hole assembly 114, which may include, but is not limited to, roller cone bits, PDC bits, natural diamond bits, any hole openers, reamers, coring bits, etc.

It should be clearly understood that the example system 100 illustrated by FIG. 1 is merely a general application of the principles of this disclosure in practice, and a wide variety of other examples are possible. Therefore, the scope of this disclosure is not limited in any manner to the details of FIG. 1 as described herein.

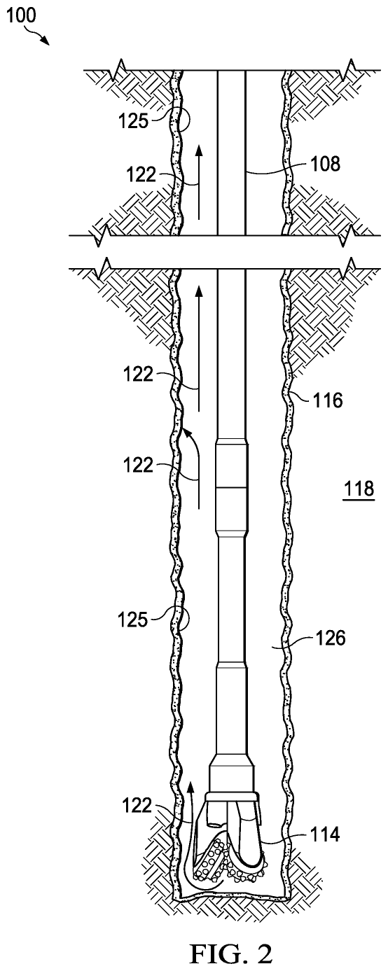

FIG. 2 is a schematic illustrating an enlarged view of the dissolution of the filter cake 125 by the treatment fluid 122 as discussed above and illustrated in FIG. 1. As illustrated, wellbore 116 has been drilled into the subterranean formation 118. While wellbore 116 is shown extending generally vertically into the subterranean formation 118, the principles described herein are also applicable to wellbores that extend at an angle through the subterranean formation 118, such as horizontal and slanted wellbores. As illustrated, the wellbore 116 comprises walls that are coated with a filter cake 125.

With continued reference to FIG. 2, the treatment fluid 122 may be pumped down the interior of the drill string 108. The treatment fluid 122 may be allowed to flow out of the bottom hole assembly 114 and into the annulus 126. As the treatment fluid 122 flows upward through the annulus 126, the treatment fluid 122 may contact at least a portion of the filter cake 125. At least a portion of the filter cake 125 that is contacted by the treatment fluid 122 may be dissolved. The treatment fluid 122 may carry the dissolved filter cake 125 as well as any undissolved remnants to the surface to be removed from the wellbore 116.

While not illustrated, other wellbore 116 introduction techniques may also be utilized for introduction of the treatment fluid 122 into the wellbore 116. By way of example, reverse circulation techniques may be used that include introducing the treatment fluid 122 into the wellbore 116 by way of the annulus 126 instead of through the drill string 108.

It should be clearly understood that the example system 100 illustrated by FIG. 2 is merely a general application of the principles of this disclosure in practice, and a wide variety of other examples are possible. Therefore, the scope of this disclosure is not limited in any manner to the details of FIG. 2 as described herein.

The treatment fluid comprises a phosphate and an aqueous fluid. Examples of the phosphate include, but are not limited to, sodium hexametaphosphate, monosodium phosphate, disodium phosphate, sodium triphosphate, salts thereof, derivatives thereof, or any combination thereof.

The concentration of the phosphate in the treatment fluid may range from about 5% (w/v) to about 50% (w/v). The concentration may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the phosphate in the treatment fluid may range, from about 5% (w/v) to about 50% (w/v), from about 10% (w/v) to about 50% (w/v), from about 15% (w/v) to about 50% (w/v), from about 20% (w/v) to about 50% (w/v), from about 25% (w/v) to about 50% (w/v), from about 30% (w/v) to about 50% (w/v), from about 35% (w/v) to about 50% (w/v), from about 40% (w/v) to about 50% (w/v), or from about 45% (w/v) to about 50% (w/v). As another example, the concentration of the phosphate in the treatment fluid may range from about 5% (w/v) to about 50% (w/v), from about 5% (w/v) to about 45% (w/v), from about 5% (w/v) to about 40% (w/v), from about 5% (w/v) to about 35% (w/v), from about 5% (w/v) to about 30% (w/v), from about 5% (w/v) to about 25% (w/v), from about 5% (w/v) to about 20% (w/v), from about 5% (w/v) to about 15% (w/v), or from about 5% (w/v) to about 10% (w/v). With the benefit of this disclosure, one of ordinary skill in the art will be readily able to prepare a treatment fluid having a sufficient concentration of phosphate for a given application.

The treatment fluid comprises an aqueous fluid to convey the phosphate to the filter cake and to assist carrying the phosphate, the dissolved filter cake, and the undissolved filter cake remnants to the surface. The aqueous fluid may be from any source, provided that it does not contain an excess of compounds that may undesirably affect other components in the treatment fluid. In various examples, the aqueous fluid may comprise fresh water, salt water, seawater, brine, or an aqueous salt solution. In some examples, the aqueous fluid may comprise a monovalent brine. Suitable monovalent brines include, but are not limited to, sodium chloride brines, sodium bromide brines, potassium chloride brines, potassium bromide brines, and the like. In some examples, the phosphate salts act as a brine and may impart sufficient density to the aqueous fluid to suspend the filter cake remnants in the treatment fluid.

The concentration of the aqueous fluid in the treatment fluid may range from about 0.5% (w/v) to about 99.9% (w/v). The concentration of the aqueous fluid in the treatment fluid may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the aqueous fluid in the treatment fluid may range from about 0.5% (w/v) to about 99.9% (w/v), from about 1% (w/v) to about 99.9% (w/v), from about 5% (w/v) to about 99.9% (w/v), from about 10% (w/v) to about 99.9% (w/v), from about 15% (w/v) to about 99.9% (w/v), from about 20% (w/v) to about 99.9% (w/v), from about 25% (w/v) to about 99.9% (w/v), from about 30% (w/v) to about 99.9% (w/v), from about 35% (w/v) to about 99.9% (w/v), from about 40% (w/v) to about 99.9% (w/v), from about 45% (w/v) to about 99.9% (w/v), from about 50% (w/v) to about 99.9% (w/v), from about 55% (w/v) to about 99.9% (w/v), from about 60% (w/v) to about 99.9% (w/v), from about 65% (w/v) to about 99.9% (w/v), from about 70% (w/v) to about 99.9% (w/v), from about 75% (w/v) to about 99.9% (w/v), from about 80% (w/v) to about 99.9% (w/v), from about 85% (w/v) to about 99.9% (w/v), from about 90% (w/v) to about 99.9% (w/v), from about 95% (w/v) to about 99.9% (w/v), or from about 99% (w/v) to about 99.9% (w/v). As another example, the concentration of the aqueous fluid in the treatment fluid may range from about 0.5% (w/v) to about 99.9% (w/v), from about 0.5% (w/v) to about 99% (w/v), from about 0.5% (w/v) to about 95% (w/v), from about 0.5% (w/v) to about 90% (w/v), from about 0.5% (w/v) to about 85% (w/v), from about 0.5% (w/v) to about 80% (w/v), from about 0.5% (w/v) to about 75% (w/v), from about 0.5% (w/v) to about 70% (w/v), from about 0.5% (w/v) to about 65% (w/v), from about 0.5% (w/v) to about 60% (w/v), from about 0.5% (w/v) to about 55% (w/v), from about 0.5% (w/v) to about 50% (w/v), from about 0.5% (w/v) to about 45% (w/v), from about 0.5% (w/v) to about 40% (w/v), from about 0.5% (w/v) to about 35% (w/v), from about 0.5% (w/v) to about 30% (w/v), from about 0.5% (w/v) to about 25% (w/v), from about 0.5% (w/v) to about 20% (w/v), from about 0.5% (w/v) to about 15% (w/v), from about 0.5% (w/v) to about 10% (w/v), from about 0.5% (w/v) to about 5% (w/v), or from about 0.5% (w/v) to about 1% (w/v). With the benefit of this disclosure, one of ordinary skill in the art will be able to prepare a treatment fluid having an aqueous fluid for a given application.

Optionally, the treatment fluid comprises an activator to increase the rate of dissolution of the filter cake. In these examples, the activator is an acid or is an acid generator. An acid generator is a molecule that generates acid upon exposure to the aqueous fluid. Examples of the activator include, but are not limited to, orthophosphoric acids, mineral acids, inorganic acids, derivatives thereof, or any combination thereof.

The concentration of the activator in the treatment fluid may range from about 0.1% (w/v) to about 15% (w/v). The concentration may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the activator in the treatment fluid may range, from about 0.1% (w/v) to about 15% (w/v), from about 1% (w/v) to about 15% (w/v), from about 3% (w/v) to about 15% (w/v), from about 5% (w/v) to about 15% (w/v), or from about 10% (w/v) to about 15% (w/v). As another example, the concentration of the activator in the treatment fluid may range from about 0.1% (w/v) to about 15% (w/v), from about 0.1% (w/v) to about 10% (w/v), from about 0.1% (w/v) to about 5% (w/v), from about 0.1% (w/v) to about 3% (w/v), or from about 0.1% (w/v) to about 1% (w/v). With the benefit of this disclosure, one of ordinary skill in the art will be readily able to prepare a treatment fluid having a sufficient concentration of activator for a given application.

The treatment fluid may have a density in a range of about 8.5 ppg to about 12 ppg. In some examples, the density of the treatment fluid is in a range of about 8.5 to about 11. In some examples, the density of the treatment fluid may be achieved by the addition of the phosphate alone without the use of any additional density altering agents. Examples of density altering agents include, but are not limited to, different salts such as sodium chloride, sodium bromide, potassium chloride, potassium bromide, etc.

The treatment fluid comprises a pH in a range of about 5 to about 7. A pH adjustor may be added to shift the pH to a desired range. The pH adjustor may be any acid or base sufficient for adjusting the pH of the treatment fluid to a range of about 5 to about 7 without negatively impacting the functionality of the other treatment fluid components.

In some optional examples, the treatment fluid may comprise an additive. The additive may be used to adjust a property of the treatment fluid, for example, viscosity, density, etc. Examples of the additives include, but are not limited to, silica scale control additives, corrosion inhibitors, surfactants, gel stabilizers, anti-oxidants, polymer degradation prevention additives, relative permeability modifiers, scale inhibitors, foaming agents, defoaming agents, antifoaming agents, emulsifying agents, de-emulsifying agents, iron control agents, proppants or other particulates, particulate diverters, salts, fluid loss control additives, gas, catalysts, clay control agents, dispersants, flocculants, scavengers (e.g., H₂S scavengers, CO₂ scavengers or O₂ scavengers), gelling agents, lubricants, friction reducers, bridging agents, viscosifiers, weighting agents, solubilizers, hydrate inhibitors, consolidating agents, bactericides, clay stabilizers, breakers, the like, or any combination thereof. With the benefit of this disclosure, one of ordinary skill in the art and the benefit of this disclosure will be able to formulate a treatment fluid having properties suitable for a desired application.

In some examples, the treatment fluid will consist of or consist essentially of the aqueous fluid and the phosphate. In some alternative examples, the treatment fluid will consist of or consist essentially of the aqueous fluid, the phosphate, and the activator. In some examples, the treatment fluid does not comprise a corrosion inhibitor. Examples of corrosion inhibitors may include, but are not limited to, aromatic/aliphatic quaternary amines, amides and salts thereof, aromatic aldehydes, thioglycolic acid, alkylphenones or imidazoline based products, derivatives thereof, or combinations thereof.

### EXAMPLES

The present disclosure may be better understood by reference to the following examples, which are offered by way of illustration. The present disclosure is not limited to the examples provided herein.

### Example 1

Example 1 illustrates an example experiment to test the dissolution of a filter cake material comprising calcium carbonate. Two experimental samples were prepared containing two different concentrations of sodium hexametaphosphate (“SHMP”) in a treatment fluid of 200 mL water. One gram of the filter cake material was added to each experimental sample. The samples were then allowed to sit for 72 hours before being filtered to obtain the percent dissolution value. The results are illustrated below in Table 1.

TABLE 1

| Sample No. | Concentration of SHMP | % Dissolution after 72 Hrs. |
|---|---|---|
| 1 | 5% SHMP in 200 mL Water | 47.16 |
| 2 | 10% SHMP in 200 mL Water | 62.79 |

### Example 2

Example 2 illustrates an example experiment to test the dissolution of a filter cake material comprising calcium carbonate and an activator. Three experimental samples were prepared containing three different concentrations of an orthophosphonic acid (an activator). SHMP was added to a treatment fluid of 200 mL water for a concentration of 5% w/v. A control sample was prepared which only contained the 5% SHMP solution with no activator. One gram of the filter cake material was added to each experimental sample. The samples were then allowed to sit for 72 hours at 25° C. before being filtered to obtain the percent dissolution value. The results are illustrated below in Table 2.

TABLE 2

| Sample | Concentration of | Remaining Filter | % Dissolution after |
|---|---|---|---|
| No. | Activator (v/v) | Cake Material (g) | 72 Hrs. |
| 1 | 0 | 0.5284 | 47.16 |
| 2 | 0.25% | 0.2773 | 72.27 |
| 3 | 0.50% | 0.2634 | 73.66 |
| 4 | 0.75% | 0.2157 | 78.43 |

### Example 3

Example 3 illustrates an example experiment to test the dissolution of reservoir drilling fluid filter cake using SHMP. The reservoir drilling fluid was formulated according to the formation of Table 3. The fluid was hot rolled at 66° C. for 16 hrs. before the filter cake was built up. The reservoir drilling fluid filter cake was then prepared on a 20-micron ceramic disc at 25° C. in a high-temperature, high-pressure cell (“HTHP”). After the filter cake was formed on the disc, the excess fluid was removed by pouring the fluid from the HPHT cell. The filter cake breaker solution was formulated using a concentration of 15% w/v SHMP and was prepared in deionized water. A comparative sample of a 15% v/v in-situ organic acid generator was also prepared in deionized water. The filter cake disc was soaked with the respective treatment solution in the HTHP cell and then the HTHP cell was placed in a preheated HPHT jacket at 25° C. for 24 to 72 hrs. After the measured test period the HTHP cells were opened, and the filter cake dissolution was observed visually. A greater degree of filter cake dissolution (>90%) was observed for the SHMP-based treatment fluid whereas less than 50% of filter cake dissolution was observed with the in-situ acid generator-based treatment fluid.

TABLE 3

| Component | Quantity |
|---|---|
| Deionized water | 324 ml |
| Potassium Chloride | 10.33 g |
| A crosslinked starch (fluid loss control | 8.75 g |
| agent) | |
| A Xanthan gum polymer viscosifier | 1.00 g |
| A CaCO₃ particulate bridging material | 40 g |
| (Various mesh sizes) | |
| An alkaline buffer (magnesium oxide) | 1.00 g |

### Example 4

Example 4 illustrates an example experiment to test the corrosion rate of SHMP. A test sample of 10% w/v SHMP was prepared in 9 pounds per gallon (“ppg”) brine of sodium bromide. A comparative sample of a 10% v/v in-situ organic acid generating solution was prepared in a 9 ppg brine of sodium bromide. Corrosion test coupons were immersed in the respective solutions. The testing parameters are illustrated below in Table 3 and the results are listed in Table 4.

TABLE 4

| | |
|---|---|
| Test Sample | 10% w/v SHMP in 9 ppg NaBr brine |
| Comparative Sample | 10% v/v In Situ Organic Acid Generator |
| | in 9 ppg NaBr Brine |
| Test Temperature | 25° C. |
| Test Duration | 7 days |

TABLE 5

| | | Average | Average | | |
|---|---|---|---|---|---|
| | | of Initial | of Final | % | Corrosion |
| | | Coupon | Coupon | Weight | Rate |
| Sample Type | Component | Weight (g) | Weight (g) | Loss | mm/yr |
| Test Sample | SHMP | 21.3639 | 21.2872 | 0.36% | 30.84 |
| Comparative | In-situ | 21.4387 | 20.6096 | 3.87% | 333.32 |
| Sample | Organic | | | | |
| | Acid | | | | |
| | Generator | | | | |

It is also to be recognized that the disclosed treatment fluids may also directly or indirectly affect the various downhole equipment and tools that may contact the treatment fluids disclosed herein. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the methods and systems generally described above and depicted in FIGS. 1-2.

Provided are methods of treating a subterranean formation in accordance with the disclosure and the illustrated FIGs. An example method comprises introducing a treatment fluid into an annulus of a wellbore penetrating the subterranean formation, wherein the treatment fluid comprises: an aqueous fluid and a phosphate. The wellbore comprises a wall that is at least partially coated with a filter cake. The method further comprises removing at least a portion of the filter cake from the wall.

Additionally or alternatively, the method may include one or more of the following features individually or in combination. Removing the portion of the filter cake may comprise dissolving the portion of the filter cake in the treatment fluid and pumping the dissolved filter cake out of the wellbore. The treatment fluid may be a drilling fluid, clean-up fluid, workover fluid, or a spotting fluid. The treatment fluid may be provided as a pill of 500 bbl or less. The wellbore may have a temperature of between about 0° C. to about 35° C. The filter cake may comprise calcium carbonate. The phosphate may be selected from the group consisting of sodium hexametaphosphate, monosodium phosphate, disodium phosphate, sodium triphosphate, and any combination thereof. The phosphate may be present in the treatment fluid in a concentration in a range of between about 0.1% (w/v) to about 50% (w/v). The treatment fluid may further comprise an activator selected from the group consisting of orthophosphoric acids, mineral acids, inorganic acids, and any combination thereof. The activator may be present in the treatment fluid in a concentration in a range of between about 0.1% (w/v) to about 15% (w/v).

Provided are treatment fluids for treating a subterranean formation in accordance with the disclosure and the illustrated FIGs. An example treatment fluid comprises an aqueous fluid and a phosphate.

Additionally or alternatively, the treatment fluid may include one or more of the following features individually or in combination. The phosphate may be selected from the group consisting of sodium hexametaphosphate, monosodium phosphate, disodium phosphate, sodium triphosphate, and any combination thereof. The phosphate may be present in the treatment fluid in a concentration in a range of between about 0.1% (w/v) to about 50% (w/v). The treatment fluid may further comprise an activator selected from the group consisting of orthophosphoric acids, mineral acids, inorganic acids, and any combination thereof. The activator may be present in the treatment fluid in a concentration in a range of between about 0.1% (w/v) to about 15% (w/v).

Provided are systems for treating a subterranean formation in accordance with the disclosure and the illustrated FIGs. An example system comprises a treatment fluid comprising an aqueous fluid and a phosphate. The system further comprises mixing equipment configured to mix the aqueous fluid and the phosphate to provide the treatment fluid. The system also comprises pumping equipment configured to pump the treatment fluid into a wellbore penetrating the subterranean formation.

Additionally or alternatively, the system may include one or more of the following features individually or in combination. The system may further comprise a drill string to convey the treatment fluid within the wellbore. The system may further comprise a bottomhole assembly to eject the treatment fluid into an annulus of the wellbore. The phosphate may be selected from the group consisting of sodium hexametaphosphate, monosodium phosphate, disodium phosphate, sodium triphosphate, and any combination thereof. The phosphate may be present in the treatment fluid in a concentration in a range of between about 0.1% (w/v) to about 50% (w/v). The treatment fluid may further comprise an activator selected from the group consisting of orthophosphoric acids, mineral acids, inorganic acids, and any combination thereof. The activator may be present in the treatment fluid in a concentration in a range of between about 0.1% (w/v) to about 15% (w/v)/The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps. The systems and methods can also “consist essentially of or “consist of the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited. In the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

One or more illustrative examples incorporating the examples disclosed herein are presented. Not all features of a physical implementation are described or shown in this application for the sake of clarity. Therefore, the disclosed systems and methods are well adapted to attain the ends and advantages mentioned, as well as those that are inherent therein. The particular examples disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown other than as described in the claims below. It is therefore evident that the particular illustrative examples disclosed above may be altered, combined, or modified, and all such variations are considered within the scope of the present disclosure. The systems and methods illustratively disclosed herein may suitably be practiced in the absence of any element that is not specifically disclosed herein and/or any optional element disclosed herein.

Although the present disclosure and its advantages have been described in detail, it should be understood that various changes, substitutions and alterations can be made herein without departing from the spirit and scope of the disclosure as defined by the following claims.

What is claimed is:

1. A method for treating a subterranean formation, the method comprising:
introducing a treatment fluid into an annulus of a wellbore penetrating the subterranean formation, wherein the treatment fluid comprises:
an aqueous fluid, and
a phosphate;
wherein the wellbore comprises a wall that is at least partially coated with a filter cake, and
removing at least a portion of the filter cake from the wall.

2. The method of claim 1, wherein the removing the portion of the filter cake comprises dissolving the portion of the filter cake in the treatment fluid and pumping the dissolved filter cake out of the wellbore.

3. The method of claim 1, wherein the treatment fluid is a drilling fluid, clean-up fluid, workover fluid, or a spotting fluid.

4. The method of claim 1, wherein the treatment fluid is provided as a pill of 500 bbl or less.

5. The method of claim 1, wherein the wellbore has a temperature of between about 0° C. to about 35° C.

6. The method of claim 1, wherein the filter cake comprises calcium carbonate.

7. The method of claim 1, wherein the phosphate is selected from the group consisting of sodium hexametaphosphate, monosodium phosphate, disodium phosphate, sodium triphosphate, and any combination thereof.

8. The method of claim 1, wherein the phosphate is present in the treatment fluid in a concentration in a range of between about 0.1% (w/v) to about 50% (w/v).

9. The method of claim 1, wherein the treatment fluid further comprises an activator selected from the group consisting of orthophosphoric acids, mineral acids, inorganic acids, and any combination thereof.

10. The method of claim 1, wherein the activator is present in the treatment fluid in a concentration in a range of between about 0.1% (w/v) to about 15% (w/v).

11. A treatment fluid for treating a subterranean formation, the treatment fluid comprising:
an aqueous fluid, and
a phosphate.

12. The treatment fluid of claim 11, wherein the phosphate is selected from the group consisting of sodium hexametaphosphate, monosodium phosphate, disodium phosphate, sodium triphosphate, and any combination thereof.

13. The treatment fluid of claim 11, wherein the phosphate is present in the treatment fluid in a concentration in a range of between about 0.1% (w/v) to about 50% (w/v).

14. The treatment fluid of claim 11, wherein the treatment fluid further comprises an activator selected from the group consisting of orthophosphoric acids, mineral acids, inorganic acids, and any combination thereof.

15. The treatment fluid of claim 11, wherein the activator is present in the treatment fluid in a concentration in a range of between about 0.1% (w/v) to about 15% (w/v).

16. A system for treating a subterranean formation, the system comprising:
a treatment fluid comprising:
an aqueous fluid, and
a phosphate,
mixing equipment configured to mix the aqueous fluid and the phosphate to provide the treatment fluid, and
pumping equipment configured to pump the treatment fluid into a wellbore penetrating the subterranean formation.

17. The system of claim 16, further comprising a drill string to convey the treatment fluid within the wellbore.

18. The system of claim 16, further comprising a bottomhole assembly to eject the treatment fluid into an annulus of the wellbore.

19. The system of claim 16, wherein the phosphate is selected from the group consisting of sodium hexametaphosphate, monosodium phosphate, disodium phosphate, sodium triphosphate, and any combination thereof.

20. The system of claim 16, wherein the treatment fluid further comprises an activator selected from the group consisting of orthophosphoric acids, mineral acids, inorganic acids, and any combination thereof.
